(19) United States
(12) Patent Application Publication
(10) Pub. No.: US 2006/0237148 A1
(43) Pub. Date: Oct. 26, 2006

(54) Assembly structure of magnetic clutching device of cord bracket for window blind

(75) Inventor: Shien-Te Huang, Taipei (TW)

Correspondence Address: Ching Feng Home Fashions Co., Ltd., P.O. Box No. 6-57, Junghe, Taipei, 235, TW

(73) Assignee: Ching Feng Home Fashions Co., Ltd.

(21) Appl. No.: 11/111,811

(22) Filed: Apr. 22, 2005

(51) Int. Cl. E06B 9/36

(52) U.S. Cl. 160/178.1 V

(57) ABSTRACT

An assembly structure of a magnetic clutching device of a cord bracket for a window blind, particularly referring to a cord bracket for supporting a cord at a midway of a top rail and an assembly structure of a magnetic element of a magnetic clutching device corresponding to a first slide seat, includes primarily metallic magnetic pieces having hook plates at their back ends for constituting a magnetic element. By latching the hook plates into a latching slot in the cord bracket, and with a latching and holding function formed at corner ends of a permanent magnet in a front part of the magnetic pieces, objects of positioning in a three-dimensional orientation and a dry assembling can be achieved.

### BACKGROUND OF THE INVENTION

(a) Field of the Invention

The present invention relates to an assembly structure of a magnetic clutching device of a cord bracket for a window blind, and more particularly to a magnetic element that provides a magnetic clutching device corresponding to a slide seat for a cord bracket which supports a cord in a top rail of a window blind, so as to assure a long term usage by dry assembling and to obtain an effective positioning of a three-dimensional orientation.

As shown in FIG. 1, a basic structure of a vertical window blind includes primarily a top rail 1 inside which are mounted with a plurality of slide seats 200. A hanging shaft 21 is extended downward from each slide seat 200 for hanging vertical panels 10. A pull cord 110 is looped inside the top rail 1 having a transmission shaft 120 in a longitudinal direction.

The transmission shaft 120 is driven by a hand rod 12 which indirectly carries the vertical panels 10 to adjust a shading angle. The pull cord 110 can drive the panels 10 to shift to right or left, so as to achieve an expansion or collapsing effect, and an operation of expanding or collapsing the panels 10 is performed by an operational part 11 of the pull cord.

Referring to FIG. 2, the pull cord 110 is located inside the top rail 1 in a longitudinal direction by a looping method, and a body of the pull cord 110 at one side is fixed onto the first slide seat 2 at a very front by a latching element 20. Therefore, upon pulling the pull cord 110, the first slide seat 2 must be moved forward accordingly.

Referring to FIG. 2A, it shows a working condition of a full shading of the panels 10, which occurs when the first slide seat 2 is moved by the pull cord 110, thereby driving the panels 10 to distribute to a shading condition.

As a linking function is formed between the first slide seat 2 and succeeding slide seats 200, therefore when the first slide seat 2 is moved, the succeeding slide seats 200 will be moved one by one.

The succeeding slide seats 200 have no direct coupling with the pull cord 110; they are moved in an orderly fashion through a linking rod 210. During a process of moving the slide seats for shading, the first slide seat 2 reaches and is combined with a pre-latched cord bracket 3, and pushes the cord bracket 3 to move toward a closed end concurrently.

Referring to FIG. 2B, it shows a schematic view of collapsing the panels. The first slide seat 2 moves toward left by an operation of the pull cord 110, and continuously pushes the succeeding slide seats 200. As being combined by a magnetic force in advance, the cord bracket 3 is also pulled to move toward left concurrently. When the cord bracket 3 reaches a midway at the top rail 1, it is seized by a stopper 13 in a center part of the top rail 1, and is decoupled magnetically with the first slide seat 1 and seized in a center position of the top rail 1 alone. The object of being positioned in a center position is to support the pull cord 110, which loses attachment, with the cord bracket 3, in order to prevent the pull cord 110 at that end from dropping. Otherwise, if the cord bracket 3 is not used, the pull cord 110 that is looped at a middle part of the top rail 1 will drop down by the gravity. Therefore, the cord bracket 3 must be used for a supporting. In addition, the aforementioned transmission shaft 120 can be also supported by the cord bracket 3.

In order that the cord bracket 3 can escape from the seized position in the center of the top rail 1, a clutching relation must be formed between the first slide seat 2 and the cord bracket 3.

Referring to FIG. 3, a clutching device 400 is used to constitute the clutching relation between the cord bracket 3 and the first slide seat 2. A best implementation of the clutching device 400 is to use a magnetic operation, which constitutes a magnetic clutching relation with a magnetic element 4 and a magnetic element with an opposite polarity 40. The magnetic element 4 can be optionally located at the position of the cord bracket 3.

A wheel 31 is located at the cord bracket 3 in the top rail 1 for facilitating moving to right or left. A latching plate 34 is located at a height of the stopper 13 relative to the cord bracket 3. A through-hole 32 in the cord bracket 3 is used for passing through the pull cord 110 (or the transmission shaft 120), and serves as a basis of support.

The first slide seat 2 is fixed at a body position of the pull cord 110 through the latching element 20, and the magnet element with an opposite polarity 40 is located at a position relative to the magnetic element 4 of the slide seat 2, so as to obtain a magnetic clutching function by a magnetic absorption between the magnetic element 4 and the magnetic element with the opposite polarity 40.

Accordingly, in order to prevent the pull cord from dropping down at a center position of the top rail after collapsing the panels, a cord bracket is used as a means of support. The cord bracket must move with the first slide seat. However, when the first slide seat moves backward, the cord bracket must be latched in a center position of the top rail, in order to uniformly support the pull cord or the transmission shaft that may drop down. Whereas a magnetic clutching device is introduced, enabling the cord bracket to be escaped and fixed on a center position of the top rail.

(b) Description of the Prior Art

Referring to FIG. 4, a conventional assembly method of a magnetic clutching device uses a glue to combine a magnetic element 4 at a latching slot 33 of a cord bracket 3. The magnetic element 4 is formed by sticking two metallic magnetic pieces 41, 42 on a permanent magnet 43, and then is latched inside the latching slot 33 by pasting glue on an outer surface.

The assembly must be operated by glue, thereby complicating an operational procedure and requiring waiting for a solidifying time as the magnetic element can be falling off by an external force before being solidified.

Moreover, the magnetic element 4 is glued onto an inner surface of the latching slot 33, wherein a homogeneous coalescence effect can be achieved between the glue and the latching slot 33, as the latching slot 33 is made by a plastic ejection molding process. However, a homogeneous fusion effect cannot be achieved between the glue and the metallic magnetic pieces 41, 42, therefore the magnetic pieces 41, 42 and the permanent magnet 43 will be loosened due to a physical change from a long term usage.

Furthermore, according to a mechanical and structural analysis, the metallic magnetic pieces 41, 42 are in a smooth shape and parallel latched into the latching slot 33, therefore an adhesive force in other orientation cannot be created, thereby causing the magnetic element 4 to easily fall off after being loosened.

### SUMMARY OF THE INVENTION

In lieu of the aforementioned shortcomings, the present invention uses hook plates at back sides of the magnetic pieces to constitute mechanical hooks at the latching slot of the cord bracket, and forms wrapping edges having a wrapping and holding function to corners of the permanent magnet at magnetic absorption ends in a front part of the magnetic pieces, so as to achieve the objects of mechanical positioning in a three-dimensional orientation and a dry assembly operation, thereby assuring a long term and secured assembly.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a structure of a conventional vertical window blind.

FIG. 2 shows a schematic view of a combination of a conventional pull cord and a slide seat.

FIG. 2A shows a prior art of working condition when panels are in a position of complete shading.

FIG. 2B shows a prior art structure of schematic view upon collapsing panels.

FIG. 3 shows a prior art structure for schematic view of an operation of a cord bracket relative to a first slide seat.

FIG. 4 shows a schematic view of a conventional assembly of a cord bracket and a magnetic element.

FIG. 5 shows a schematic view of an assembly of a cord bracket of the present invention.

FIG. 6 shows a top view of a magnetic element of the present invention.

FIG. 7 shows a schematic view of an assembly of a cord bracket and a magnetic element of the present invention.

FIG. 8 shows a cutaway view of an assembly of a magnetic element in a latching slot of a cord bracket of the present invention.

FIG. 9 shows a front view of a magnetic piece with a stress absorption groove of the present invention.

FIG. 10 shows a front view of a hook plate with pushing edges of the present invention.

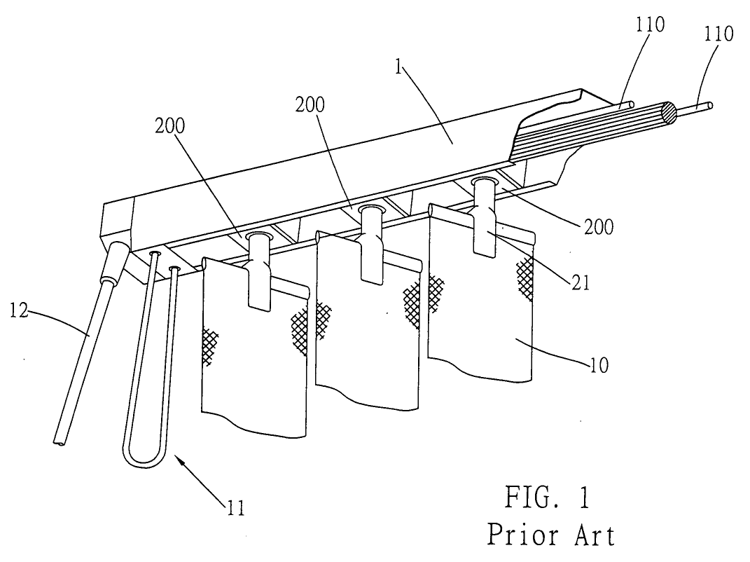

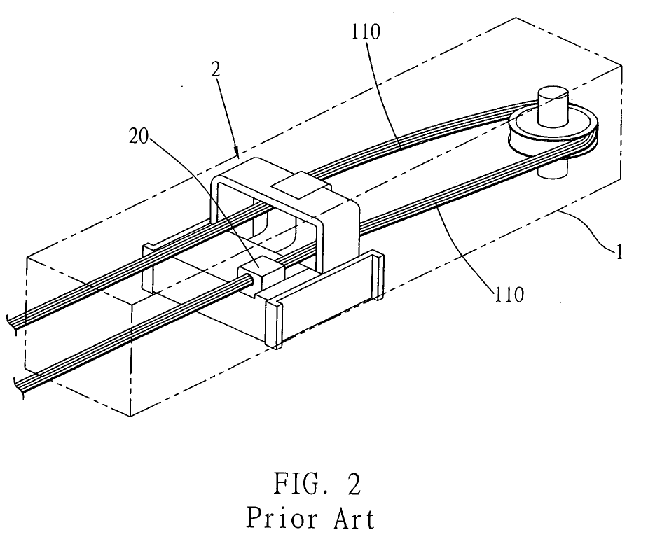

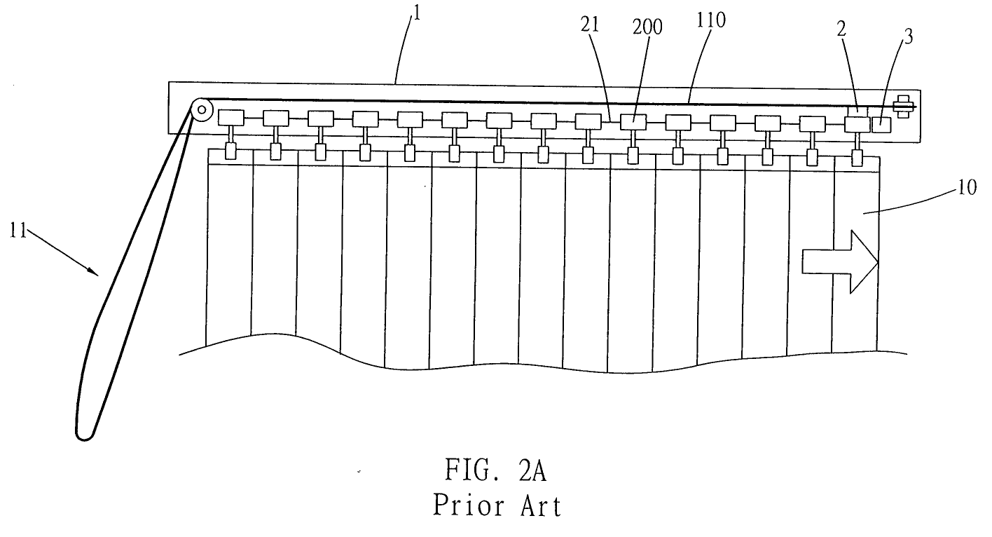

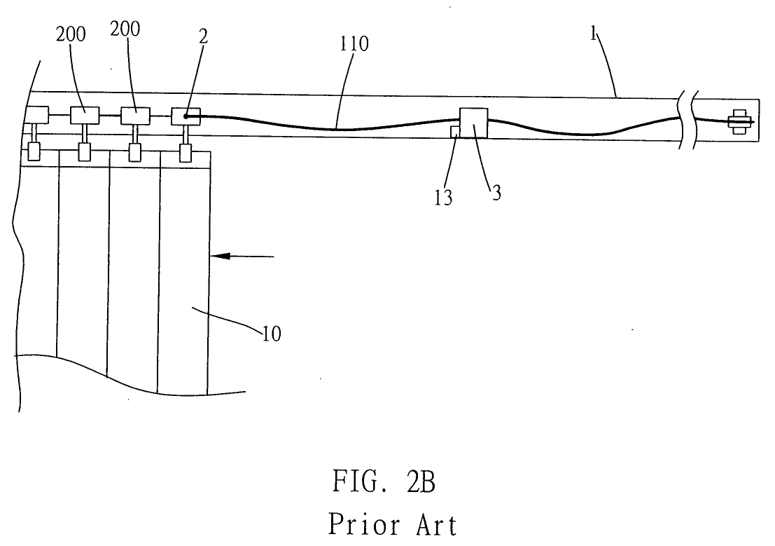

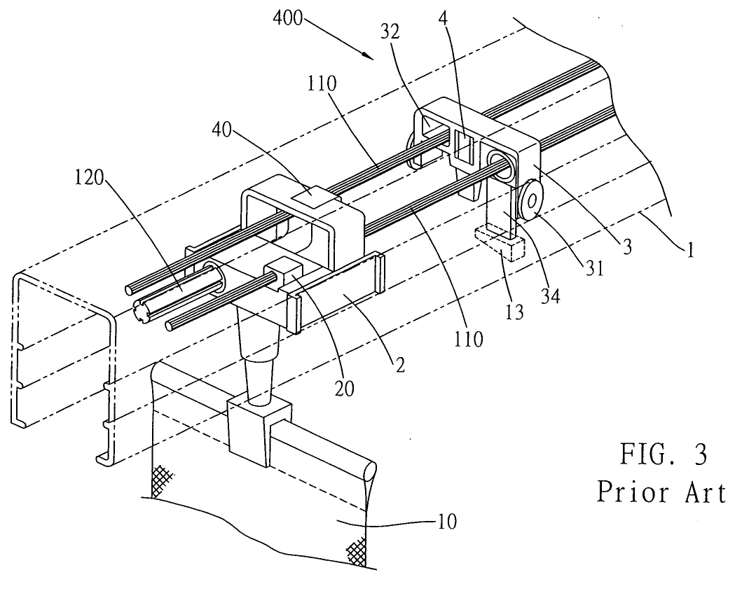

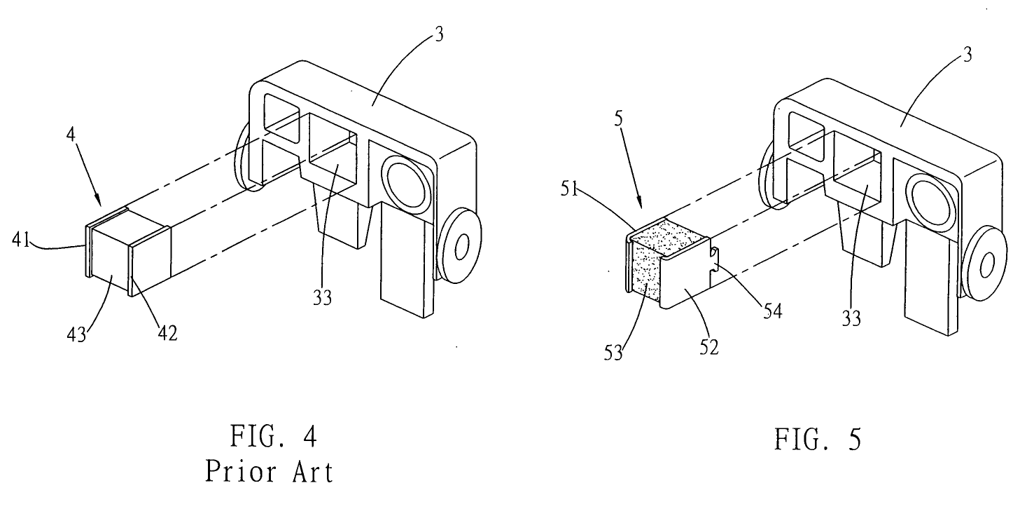

### DETAILED DESCRIPTION OF THE PREFERRED EMBODIMENTS

Referring to FIG. 5, a magnetic element 5 is latched into a latching slot 33 in a cord bracket 3. The magnetic element 5 is constituted by magnetic pieces 51, 52 having fin-shape hook plates 54 at their rear ends and a permanent magnet 53 sandwiched between the magnetic pieces 51, 52.

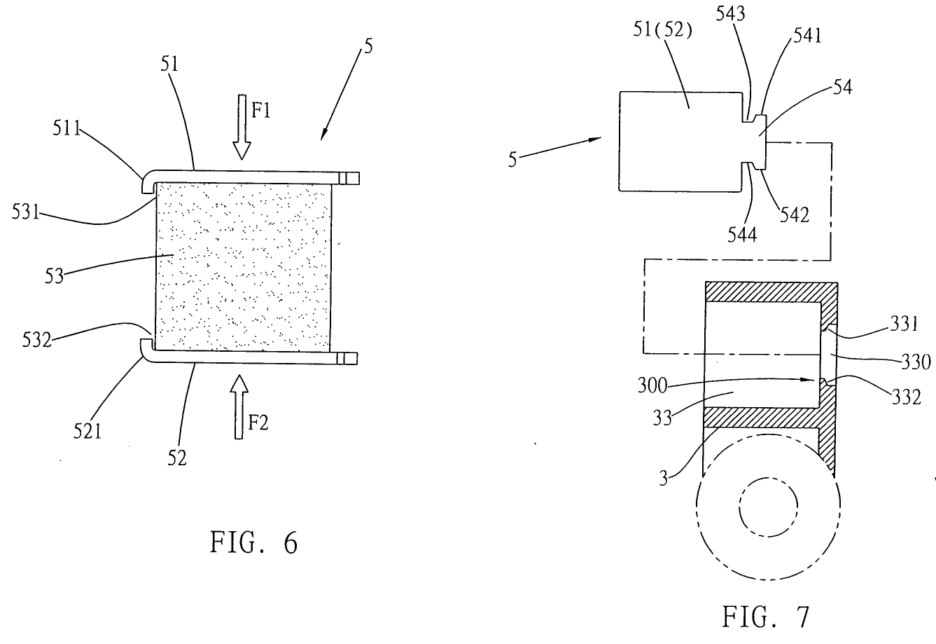

Referring to FIG. 6, wrapping edges 511, 521 having a wrapping and holding function to corners 531, 532 of a permanent magnet 53 are formed at magnetic absorption ends at a front of the magnetic pieces 51, 52, such that the wrapping edges 511, 521 can effectively wrap the magnet 53 when supported by external forces F1, F2.

Referring to FIG. 7, hook plates 54 are located at rear ends of the magnetic pieces 51, 52, and latching holes 330 are located at a back side 300 of the latching slot 33 in the cord bracket 3, corresponding to the positions of the hook plates 54. A left and right positioning can be achieved with a provision of latching to the hook plates 54 by the latching holes 330.

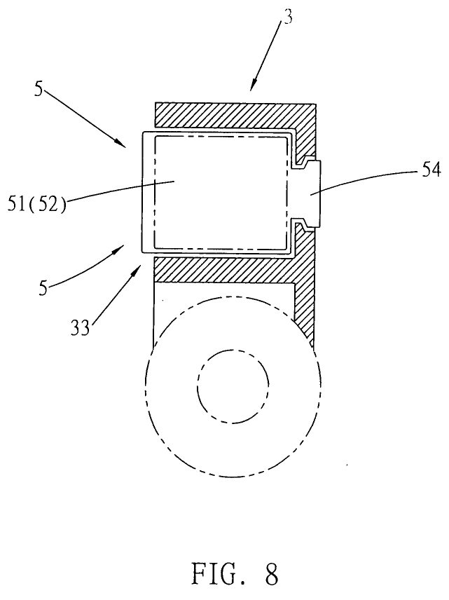

Referring to FIG. 8, after the magnetic element 5 enters the latching slot 33, an upper and lower positioning can be achieved by restrictions of an upper, a lower, a left, and a right face of the latching slot 33. Therefore, a restriction of a three-dimensional orientation can be formed to the whole magnetic element 5, so as to safely assemble the magnetic element 5 into the cord bracket 3.

Referring to FIG. 7, at least one hook tooth 541 or 542 is located at the hook plates 54, and grooves 543, 544 are formed at corner positions of the magnetic pieces 51, 52, relative to the hook teeth 541, 542. The grooves 543, 544 are used to latch concaved hook edges 331, 332 at the latching hole 330 for fixing. On the other hand, an operation of latching the hook plates 54 into the latching hole 330 is by pushing the whole magnetic element 5 inside with an external force. After a pushing pressure exceeds an elastic deformation force of the hook edges 331, 332, the hook plates 54 can be completely latched into the latching hole 330 to accomplish a dry assembly operation.

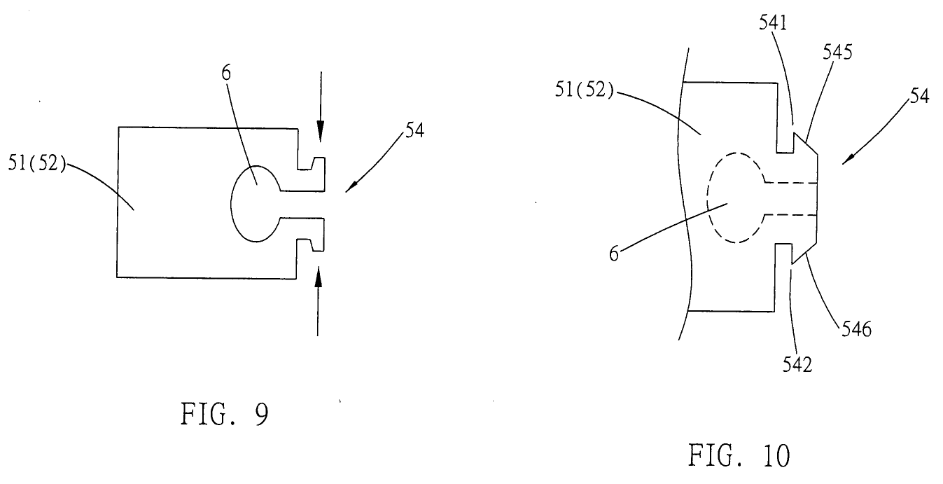

Referring to FIG. 9, except that the concaved hook edges 331, 332 as shown in FIG. 7 can be employed to latch the hook plates 54 into the latching hole 330 with an elastic plastic deformation, stress absorption grooves 6 in an opening mouth shape can be opened inside breadths of the magnetic pieces 51, 52, at positions connecting to the hook plates 54, so as to form an elastic contraction to the hook plates 54 by a push of external force upon assembling, thereby facilitating latching the hook plates 54 into the latching hole 330 of the latching slot 33 with a contraction deformation.

Referring to FIG. 10, slant pushing edges 545, 546 can be formed at external sides of the hook teeth 541, 542 of the hook plates 54 on the magnetic pieces 51, 52. The hook plates 54 can be easily passed through the latching hole 330 without resistance by a variation of orientation of the slant pushing edges 545, 546. Similarly, the stress absorption groove 6 can be located at a related position, such that a contraction deformation can be created to the hook plates 541, 542, thereby facilitating assembling.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An assembly structure of a magnetic clutching device of a cord bracket for a window blind, more particularly referring to a cord bracket for supporting a cord at a central section of a top rail of a window blind, and an assembly structure of a magnetic element of a magnetic clutching device installed corresponding to a slide seat, comprising primarily a cord bracket provided with a latching slot for latching a magnetic element which is constituted by a block of permanent magnet whose two sides are stuck with magnetic pieces; a latching hole located at a back side of the latching slot for latching at least one magnetic piece by hook plates at rear ends of the magnetic pieces, and wrapping edges formed at corner ends of the permanent magnet, in a front part of the magnetic piece.

2. The assembly structure of a magnetic clutching device of a cord bracket for a window blind according to claim 1, wherein wrapping edges are located in a front part of the two magnetic pieces, in corner positions of the magnet, respectively.

3. The assembly structure of a magnetic clutching device of a cord bracket for a window blind according to claim 1, wherein at least one hook tooth is located at the hook plates of the magnetic pieces.

4. The assembly structure of a magnetic clutching device of a cord bracket for a window blind according to claim 3, wherein the hook teeth are symmetrically located at an upper and a lower position of the hook plates.

5. The assembly structure of a magnetic clutching device of a cord bracket for a window blind according to claim 1, wherein at least one concaved hook edge is located at the latching hole at a back side of the latching slot.

6. The assembly structure of a magnetic clutching device of a cord bracket for a window blind according to claim 5, wherein the hook edges are symmetrically located at an upper and a lower position of the latching hole.

7. The assembly structure of a magnetic clutching device of a cord bracket for a window blind according to claim 1, wherein stress absorption grooves are opened inside breadths of the magnetic pieces, at positions corresponding to the hook plates.

8. The assembly structure of a magnetic clutching device of a cord bracket for a window blind according to claim 1, wherein slant pushing edges are formed at external sides of the hook teeth of the hook plates.
